(19) United States
(12) Patent Application Publication
(10) Pub. No.: US 2026/0129356 A1
(43) Pub. Date: May 7, 2026

(54) LOUDSPEAKER HOUSING AND LOUDSPEAKER

(71) Applicant: MERRY ELECTRONICS (SUZHOU) CO., LTD., Suzhou City (CN)

(72) Inventors: Jiawei ZHU, Suzhou City (CN); Mingya LUO, Suzhou City (CN)

(73) Assignee: MERRY ELECTRONICS (SUZHOU) CO., LTD., Suzhou City (CN)

(21) Appl. No.: 19/020,436

(22) Filed: Jan. 14, 2025

(30) Foreign Application Priority Data
Nov. 7, 2024 (CN) 202411587159.8

(51) Int. Cl. H04R 1/34; H04R 1/02

(52) U.S. Cl. CPC H04R 1/345; H04R 1/025

(57) ABSTRACT

A loudspeaker housing and a loudspeaker are provided, which relate to the technical field of loudspeakers. The loudspeaker housing includes a shell and a sound-guiding structure which are integrally formed. The shell is provided with an assembly cavity and an installation opening, the assembly cavity is in communication with the outside through the installation opening, and a sound-emitting unit can reach into the assembly cavity through the installation opening. The sound-guiding structure is provided with a front cavity, a sound outlet and a working opening. The front cavity is in communication with the outside through the sound outlet, and is in communication with the assembly cavity through the working opening, and when the sound-emitting unit is installed in the assembly cavity, the sound-emitting unit closes the working opening. The loudspeaker adopts the above-mentioned loudspeaker housing, with which, the structure is simple.

### CROSS-REFERENCE TO RELATED APPLICATION

The present application claims priority to Chinese Patent Application No. 2024115871598, filed with the China National Intellectual Property Administration (CNIPA) on Nov. 17, 2024, the disclosure of which is incorporated herein by reference in its entirety.

### TECHNICAL FIELD

This invention relates to the technical field of loudspeakers, and in particular to a loudspeaker housing and a loudspeaker.

### BACKGROUND

A loudspeaker, commonly known as a “horn”, is a common electroacoustic transducer device that converts an electrical signal into an acoustic signal to emit a sound. Currently, a commonly used loudspeaker is composed of a single body and a housing, the housing includes an upper cover and a lower cover, the single body is the sound-emitting unit of the loudspeaker, the upper cover and the lower cover are enclosed on the outer side of the single body, and the single body can be partially exposed. However, when assembling the above-mentioned loudspeaker, a special sealing design is required for the connection between the upper cover and the lower cover, therefore, the steps are cumbersome and the structure is complex. Moreover, when producing the housing, the upper cover and the lower cover need to be produced separately, this may adversely affect the progress of large-scale mass production of loudspeakers.

### SUMMARY

An aspect of the present invention is to provide is to provide a loudspeaker housing and a loudspeaker, which can reduce the difficulty of the assembly process and improve the production efficiency.

To achieve this aspect, the following technical solutions are adopted in the present invention.

A loudspeaker housing, includes a shell and a sound-guiding structure which are integrally formed.

The shell is provided with an assembly cavity and an installation opening, the assembly cavity is in communication with the outside through the installation opening, and a sound-emitting unit can reach into the assembly cavity through the installation opening.

The sound-guiding structure is provided with a front cavity, a sound outlet and a working opening. The front cavity is in communication with the outside through the sound outlet, and is in communication with the assembly cavity through the working opening, and when the sound-emitting unit is installed in the assembly cavity, the sound-emitting unit closes the working opening.

Preferably, the sound-guiding structure includes a tubular groove body and a surrounding wall which are connected to each other. The tubular groove body and the surrounding wall are both connected to the shell. A sound-guiding cavity is defined by the tubular groove body and the shell. The sound-guiding cavity is in communication with the outside through the sound outlet. A sound-gathering cavity in communication with the sound-guiding cavity is defined by the surrounding wall and the shell. The sound-gathering cavity is in communication with the assembly cavity through the working opening. The sound-guiding cavity and the sound-gathering cavity constitute the front cavity.

Preferably, the working opening is arranged directly opposite to the installation opening.

Preferably, the opening direction of the working opening is set at an angle with respect to the opening direction of the installation opening.

Preferably, in a direction from the working opening to the sound outlet, the cross-sectional area of the sound-guiding cavity is smaller than the cross-sectional area of the sound-gathering cavity.

Preferably, the surrounding wall is provided with a side blocking part around the working opening, and the sound-emitting unit can be retained in the side blocking part.

Preferably, the sound-guiding structure is arranged in the shell, the sound outlet is arranged in an outer wall of the shell, and the assembly cavity is formed between the sound-guiding structure and an inner wall of the shell.

A loudspeaker includes a sound-emitting unit and the above-described loudspeaker housing. The sound-emitting unit is installed in the assembly cavity and closes the working opening.

Preferably, the sound-emitting unit fills the assembly cavity; or, a rear cavity is formed between the sound-emitting unit and an inner wall of the assembly cavity.

Preferably, a sealing rubber ring is sandwiched between the sound-guiding structure and the sound-emitting unit.

### BRIEF DESCRIPTION OF DRAWINGS

FIG. 1 is a schematic structural diagram of a housing according to a first embodiment of the present invention;

FIG. 2 is a schematic structural diagram of the housing according to the first embodiment of the present invention after being cut in the height direction;

FIG. 3 is a cross sectional view of a loudspeaker according to the first embodiment of the present invention;

FIG. 4 is a longitudinal sectional view of the loudspeaker according to the first embodiment of the present invention;

FIG. 5 is a schematic diagram of the cross sectional and longitudinal sectional views of varied structure of the loudspeaker according to the first embodiment of the present invention;

FIG. 6 is a schematic structural diagram of a housing according to a second embodiment of the present invention;

FIG. 7 is a schematic structural diagram of the housing according to the second embodiment of the present invention after being cut in the height direction;

FIG. 8 is a cross sectional view of a loudspeaker according to the second embodiment of the present invention;

FIG. 9 is a longitudinal sectional view of the loudspeaker according to the second embodiment of the present invention; and

FIG. 10 is a schematic diagram of the cross sectional and longitudinal sectional views of varied structures of the loudspeaker according to the second embodiment of the present invention.

### REFERENCE NUMERALS LIST

100—sound-emitting unit
1—housing
11—assembly cavity
111—rear cavity
12—installation opening
2—sound-guiding structure
21—front cavity
22—sound outlet
23—tubular groove body
231—sound-guiding cavity
24—surrounding wall
241—sound-gathering cavity
25—side blocking part
26—blocking plate
27—working opening

### DETAILED DESCRIPTION

The present invention is further described in detail hereinafter in conjunction with the drawings and embodiments. It can be understood that the embodiments described here are only intended to explain the present invention, rather than limiting the present invention. It should also be noted that, for the convenience of description, only part of structures related to the present invention rather than all the structures are shown in the drawings.

In the description of the present invention, it is to be noted that, unless otherwise clearly specified and limited, the terms “connected to each other”, “connected” or “fixed” are to be construed in a broad sense, for example, as permanently connected or detachably connected or integrally formed; mechanically connected or electrically connected; directly connected to each other or indirectly connected to each other via an intermediary; or internally connection of two components or interaction relationship between two components. For the person of ordinary skill in the art, meanings of the above terms in the present invention may be construed according to specific circumstances.

In the present invention, unless otherwise clearly specified and limited, the first feature “above” or “below” the second feature can include the first and second features directly contacting each other, and can also include the first and second features not directly contacting each other but contacting each other through another feature between them. Moreover, the first feature “on”, “above” and “over” the second feature include the first feature being directly on, above, over and diagonally on, above, over the second feature, or simply means that the first feature is higher in level than the second feature. The first feature “under”, “below” and “underneath” the second feature include the first feature being directly under, below, underneath and diagonally under, below, underneath the second feature, or simply means that the first feature is lower in level than the second feature.

In the description of this article, it should be understood that the orientation or position relationships indicated by the terms such as “upper”, “lower”, “left”, “right”, etc., are based on the orientation or position relationship shown in the drawings, which is only for the convenience of description and simplification of operation, and does not indicate or imply that the device or element referred to must have a specific orientation, be constructed and operated in a specific orientation, and therefore cannot be understood as a limitation of the present invention. Furthermore, the terms “first” and “second” are simply used to distinguish in the description and have no special meaning.

### Embodiment One

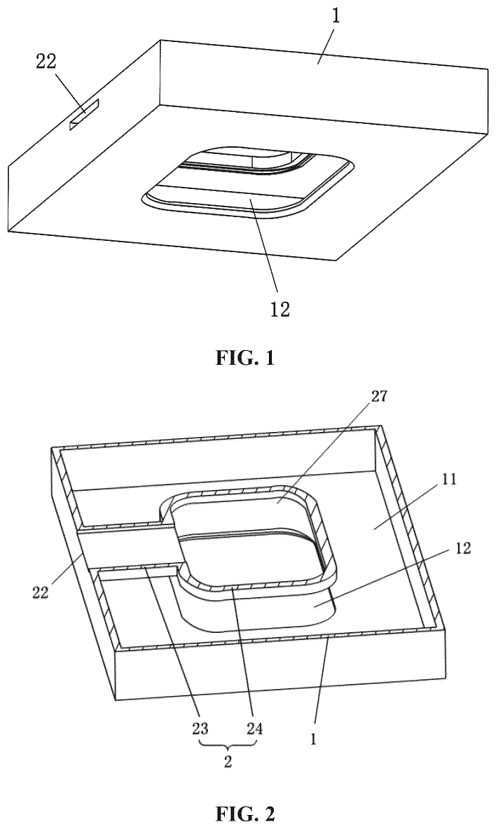

As shown in FIG. 1 to FIG. 4, a loudspeaker housing is provided according to this embodiment, the loudspeaker housing includes a shell 1 and a sound-guiding structure 2 which are integrally formed. The shell 1 is provided with an assembly cavity 11 and an installation opening 12, the assembly cavity 11 is in communication with the outside through the installation opening 12, and a sound-emitting unit 100 can reach into the assembly cavity 11 through the installation opening 12. The sound-guiding structure 2 is provided with a front cavity 21, a sound outlet 22 and a working opening 27. The front cavity 21 is in communication with the outside through the sound outlet 22, and is in communication with the assembly cavity 11 through the working opening 27. When the sound-emitting unit 100 is installed in the assembly cavity 11, the sound-emitting unit 100 closes the working opening 27. In this embodiment, the shell 1 is a cuboid in appearance, and the sound-emitting unit 100 is installed in the assembly cavity 11 of the shell 1 and closes the working opening 27 of the sound-guiding structure 2. When the sound-emitting unit 100 vibrates and makes sound, the sound waves will be transmitted to the outside through the front cavity 21 and the sound outlet 22 in sequence, so that the loudspeaker makes sound. Since the sound-guiding structure 2 and the shell 1 are integrally formed, and the shell 1 is provided with the installation opening 12 for the sound-emitting unit 100 to reach in, the loudspeaker can be assembled by simply installing the sound-emitting unit 100 in the assembly cavity 11 through the installation opening 12. The structure is simple and the installation is convenient. The assembly production can be completed without connecting multiple parts, thereby greatly improving the production efficiency of the loudspeaker and reducing the manufacturing cost of the loudspeaker.

Further, as shown in FIG. 2 to FIG. 4, the sound-guiding structure 2 includes a tubular groove body 23 and a surrounding wall 24 which are connected to each other. The tubular groove body 23 and the surrounding wall 24 are both connected to the shell 1. A sound-guiding cavity 231 is defined by the tubular groove body 23 and the shell 1. The sound-guiding cavity 231 is in communication with the outside through the sound outlet 22. A sound-gathering cavity 241 in communication with the sound-guiding cavity 231 is defined by the surrounding wall 24 and the shell 1. The sound-gathering cavity 241 is in communication with the assembly cavity 11 through the working opening 27. The sound-guiding cavity 231 and the sound-gathering cavity 241 constitute the front cavity 21. In this embodiment, the tubular groove body 23 and the surrounding wall 24 are connected as an integral structure, the surrounding wall 24 is a cylindrical structure defined by four sides, the sound-gathering cavity 241 is formed between the surrounding wall 24 and the shell 1, and the sound-gathering cavity 241 is in communication with the assembly cavity 11 through the working opening 27. The tubular groove body 23 is a structure with three sides open, and the sound-guiding cavity 231 is formed between the tubular groove body 23 and the shell 1. One end of the sound-guiding cavity 231 is in communication with the outside through the sound outlet 22, and the other end of the sound-guiding cavity 231 is in communication with the sound-gathering cavity 241. Specifically, after the sound-emitting unit 100 is installed, the sound-emitting unit 100 blocks the working opening 27, and the sound wave will be transmitted to the sound-guiding cavity 231 through the sound-gathering cavity 241 in a unidirectional manner, and finally transmitted out through the sound outlet 22.

Specifically, as shown in FIG. 2, the working opening 27 is arranged directly opposite to the installation opening 12. In this embodiment, the shell 1 is a cuboid in appearance, one of the side walls of the shell 1 is a sound outlet wall, and the sound outlet wall is provided with a sound outlet 22. A wall adjacent to the sound outlet wall is a mounting wall, the mounting wall is perpendicular to the sound outlet wall, the installation opening 12 is arranged in the mounting wall, and the working opening 27 of the sound-guiding structure 2 is arranged opposite to the installation opening 12 and is located above the installation opening 12. When installing the sound-emitting unit 100, the sound-emitting unit 100 is reached upward into the assembly cavity 11 through the installation opening 12 at the bottom, and the sound-emitting unit 100 is vertically abutted against the surrounding wall 24, thereby blocking the working opening 27 to complete the assembly of the loudspeaker.

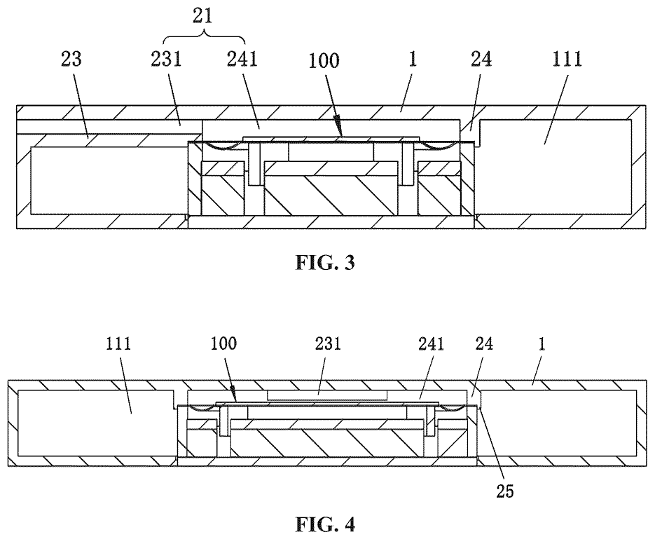

Specifically, as shown in FIG. 2 and FIG. 3, in a direction from the working opening 27 to the sound outlet 22, the cross-sectional area of the sound-guiding cavity 231 is smaller than the cross-sectional area of the sound-gathering cavity 241. In this embodiment, the sound waves generated by the vibration of the sound-emitting unit 100 will pass through the sound gathering cavity 241 and the sound-guiding cavity 231 in sequence from the working opening 27, and finally be transmitted out through the sound outlet 22, and in this direction, the cross-sectional area of the sound-guiding cavity 231 is smaller than the cross-sectional area of the sound-gathering cavity 241, which is conducive to gathering the sound waves and propagating them outward, making the sound emitted brighter.

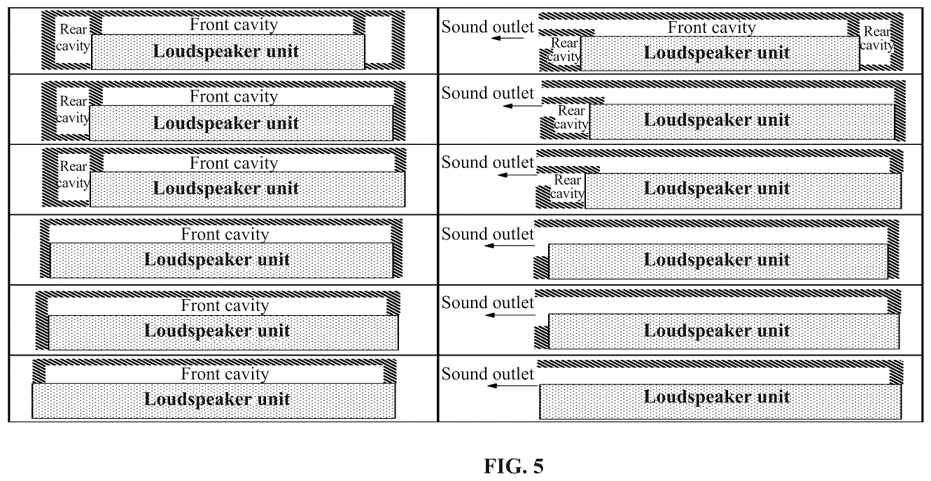

Specifically, as shown in FIG. 4, the surrounding wall 24 is provided with a side blocking part 25 around the working opening 27, and the sound-emitting unit 100 can be retained in the side blocking part 25. In this embodiment, the surrounding wall 24 is provided with the side blocking part 25 at the end close to the sound-emitting unit 100, and the side blocking part 25 is arranged around the working opening 27, the side blocking part 25 and the end of the surrounding wall 24 form a retaining recess, and the sound-emitting unit 100 can be retained in the retaining recess and abut against the side blocking part 25.

Further, as shown in FIG. 1 to FIG. 4, the sound-guiding structure 2 is arranged in the shell 1, the sound outlet 22 is arranged in an outer wall of the shell 1, and the assembly cavity 11 is formed between the sound-guiding structure 2 and an inner wall of the shell 1. In this embodiment, the sound-guiding structure 2 is integrally formed with the shell 1 and is located in the shell 1. The shell 1 is a cuboid in appearance. The sound outlet 22 is opened in one of the side walls of the shell 1. The surrounding wall 24 and the shell 1 define together the sound-gathering cavity 241, and the tubular groove body 23 and the shell 1 define together the sound-guiding cavity 231. The sound-gathering cavity 241 is in communication with the sound outlet 22 through the sound-guiding cavity 231; and the space between the sound-guiding structure 2 and an inner wall surface of the shell 1 is the assembly cavity 11 for installing the sound-emitting unit 100.

A loudspeaker is further provided according to this embodiment, which includes a sound-emitting unit 100 and the above-described loudspeaker housing. The sound-emitting unit 100 is installed in the assembly cavity 11, and closes the working opening 27. In this embodiment, the loudspeaker is assembled from the sound-emitting unit 100 and the loudspeaker housing. The loudspeaker is installed at a system end of the audio-visual device. The sound-emitting unit 100 is connected to the power line and signal line of the system end, and can generate sound waves by vibration after being energized. The sound waves are transmitted out through the sound-gathering cavity 241, the sound-guiding cavity 231 and the sound outlet 22 in sequence. Specifically, before the sound-emitting unit 100 is installed in the assembly cavity 11, the staff first applies adhesive to an end of the surrounding wall 24 close to the sound-emitting unit 100, and then installs the sound-emitting unit 100 into the assembly cavity 11 through the installation opening 12 in the installation wall to abut against the surrounding wall 24. Finally, the adhesive is applied again at the joint between the sound-emitting unit 100 and the shell 1 on the installation wall, so as to complete the connection between the sound-emitting unit 100 and the loudspeaker housing. It can be understood that the sound-emitting unit 100 may also be connected to the loudspeaker housing by ultrasonic welding.

Further, as shown in FIG. 3 and FIG. 4, the sound-emitting unit 100 fills the assembly cavity 11; or, a rear cavity 111 is formed between the sound-emitting unit 100 and an inner wall of the assembly cavity 11. In this embodiment, some small sound-emitting units 100, after being installed in the assembly cavity 11 of the shell 1, do not completely occupy the space of the assembly cavity 11, so the rear cavity 111 is formed between the sound-emitting unit 100 and the inner wall of the assembly cavity 11, the rear cavity 111 can prevent the low-frequency sound waves emitted by the sound-emitting unit 100 from short-circuiting, and further, by adjusting the structure of the rear cavity 111, the sound emitted by the loudspeaker can be more mellow and loud. While some large sound-emitting units 100, after being installed in the assembly cavity 11 of the shell 1, will completely occupy the space of the assembly cavity 11, and in this case, the rear cavity 111 exists in the space formed between the loudspeaker and the system end. It can be understood that the position of the above-described rear cavity 111 is set according to the structure and installation requirements of the audio-visual device.

Further, a sealing rubber ring is sandwiched between the sound-guiding structure 2 and the sound-emitting unit 100. In this embodiment, a sealing rubber ring is provided at the end of the surrounding wall 24 close to the sound-emitting unit 100, which can improve the sealing of the connection between the sound-guiding structure 2 and the sound-emitting unit 100, prevent the sound waves from leaking through the joint between the surrounding wall 24 and the sound-emitting unit 100 and causing loss, thereby further ensuring the sound playback effect of the loudspeaker.

As shown in FIG. 5, in this embodiment, the loudspeaker can be distinguished as several variations according to the different positions and structures of the rear cavity 111 after the loudspeaker housing and the sound-emitting unit 100 are assembled; the left column in FIG. 5 shows longitudinal sectional views of varied structures of the loudspeaker, numbered A1-A6 from top to bottom, and the right column in FIG. 5 shows cross sectional views of varied structures of the loudspeaker, numbered B1-B6 from top to bottom, so the left and right columns can be arranged and combined to generate thirty six different variations of the first embodiment; it can be understood that, for the loudspeaker housing composed of A4B4, the rear cavity 111 is not located in the assembly cavity 11.

### Embodiment Two

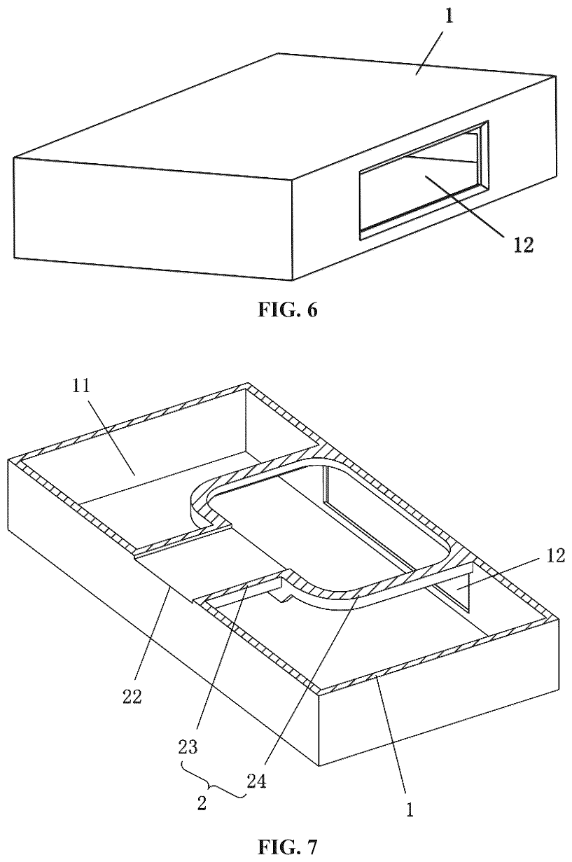

As shown in FIG. 6 to FIG. 9, a loudspeaker housing is provided according to this embodiment, which is substantially the same as the loudspeaker housing of embodiment one, and the main differences are as follows.

In this embodiment, an opening direction of the working opening 27 is set at an angle with respect to an opening direction of the installation opening 12. Specifically, the shell 1 is a cuboid in appearance, one of side walls of the shell 1 is a sound outlet wall, and the sound outlet wall is provided with a sound outlet 22. A side wall opposite to the sound outlet wall is a mounting wall, the mounting wall is parallel to the sound outlet wall, the installation opening 12 is arranged in the mounting wall, and a plane in which the working opening 27 of the sound-guiding structure 2 is located is perpendicular to the installation wall. When installing the sound-emitting unit 100, the sound-emitting unit 100 is reached into the assembly cavity 11 through the installation opening 12 at the lateral side, and the sound-emitting unit 100 is vertically abutted against the surrounding wall 24, thereby blocking the working opening 27 to complete the assembly of the loudspeaker.

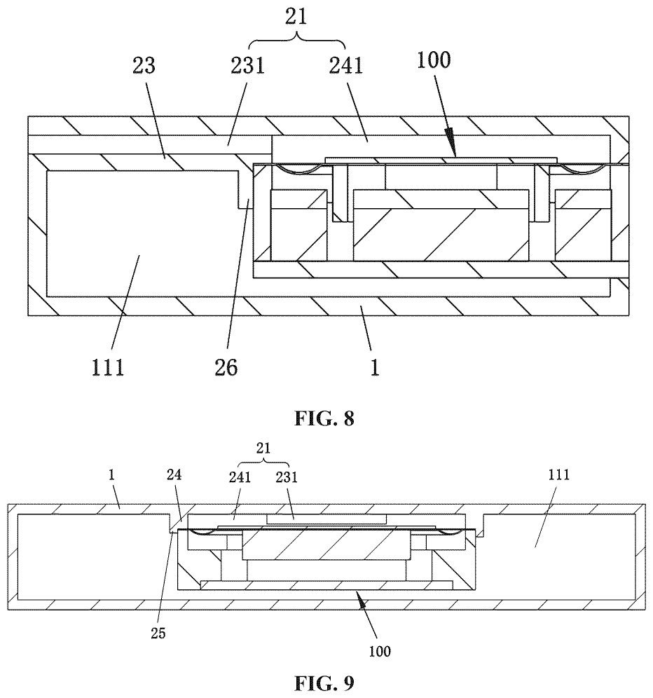

Further, as shown in FIG. 8, the surrounding wall 24 is provided with a downward blocking plate 26. After the sound-emitting unit 100 is reached into the assembly cavity 11, when it reaches the predetermined installation position, the sound-emitting unit 100 will abut against the blocking plate 26 of the surrounding wall 24, thereby ensuring that it is installed in place.

A loudspeaker is further provided according to this embodiment, which includes a sound-emitting unit 100 and the above-described loudspeaker housing. The sound-emitting unit 100 is installed in the assembly cavity 11, and closes the working opening 27. In this embodiment, the loudspeaker is assembled from the sound-emitting unit 100 and the loudspeaker housing. The loudspeaker is installed at a system end of the audio-visual device. The sound-emitting unit 100 is connected to the power line and signal line of the system end, and can generate sound waves by vibration after being energized. The sound waves are transmitted out through the sound-gathering cavity 241, the sound-guiding cavity 231 and the sound outlet 22 in sequence. Specifically, before the sound-emitting unit 100 is installed in the assembly cavity 11, the staff first applies adhesive to the end of the surrounding wall 24 close to the sound-emitting unit 100 and to the blocking plate 26, and then installs the sound-emitting unit 100 into the assembly cavity 11 through the installation opening 12 in the installation wall to abut against the blocking plate 26 in the horizontal direction and also to abut against the surrounding wall 24 in the vertical direction. Finally, the adhesive is applied again at the joint between the sound-emitting unit 100 and the shell 1 on the installation wall, so as to complete the connection between the sound-emitting unit 100 and the loudspeaker housing. It can be understood that the sound-emitting unit 100 may also be connected to the loudspeaker housing by ultrasonic welding.

Further, as shown in FIG. 8 and FIG. 9, a rear cavity 111 is formed between the sound-emitting unit 100 and an inner wall of the assembly cavity 11. In this embodiment, for the loudspeaker housing in which the opening direction of the working opening 27 is set at an angle with respect to the opening direction of the installation opening 12, the sound-emitting unit 100 is installed in the assembly cavity 11 from the lateral side, so there is always a space between the sound-emitting unit 100 and the inner wall at the bottom of the assembly cavity 11. This part of the space is the rear cavity 111, that is, in this embodiment, the rear cavity 111 exists in the assembly cavity 11.

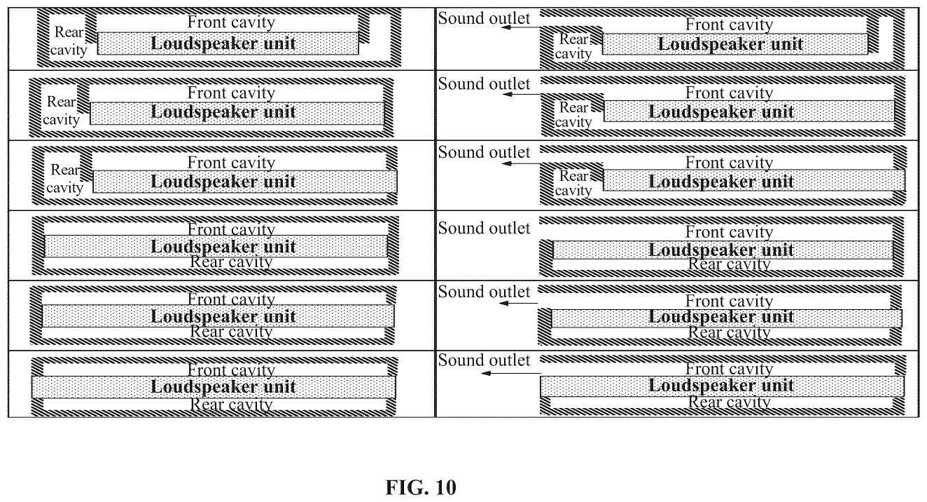

As shown in FIG. 10, in this embodiment, the loudspeaker can be distinguished as several variations according to the different positions and structures of the rear cavity 111 after the loudspeaker housing and the sound-emitting unit 100 are assembled; the left column in FIG. 10 shows longitudinal sectional views of varied structures of the loudspeaker, numbered C1-C6 from top to bottom, and the right column shows cross sectional views of varied structures of the loudspeaker, numbered D1-D6 from top to bottom, so the left and right columns can be arranged and combined to generate several different variations of the second embodiment. It should be noted that C6D6 form structures separated from top to bottom, so they cannot be used in combination. In addition, any combination of two items in the left and right columns must contain at least one of C3, C5, C6 or D3, D5, D6, otherwise the sound-emitting unit 100 cannot be installed in the assembly cavity 11; therefore, according to the above arrangement and combination, a total of twenty six different variations can be generated in the second embodiment.

Obviously, the above embodiments of the present invention are merely examples for clearly illustrating the present invention, and are not intended to limit the implementation methods of the present invention. For ordinary technicians in the relevant field, various obvious changes, readjustments and substitutions can be made without departing from the scope of protection of the present invention. It is not necessary and impossible to list all the implementation methods here. Any modification, equivalent substitution and improvement made within the spirit and principle of the present invention should be included in the scope of protection of the claims of the present invention.

What is claimed is:

1. A loudspeaker housing, comprising a shell and a sound-guiding structure which are integrally formed,
wherein the shell is provided with an assembly cavity and an installation opening, the assembly cavity is in communication with outside through the installation opening, and a sound-emitting unit is enabled to reach into the assembly cavity through the installation opening; and
the sound-guiding structure is provided with a front cavity, a sound outlet and a working opening, the front cavity is in communication with the outside through the sound outlet, and is in communication with the assembly cavity through the working opening, and when the sound-emitting unit is installed in the assembly cavity, the sound-emitting unit closes the working opening.

2. The loudspeaker housing according to claim 1, wherein the sound-guiding structure comprises a tubular groove body and a surrounding wall which are connected to each other, the tubular groove body and the surrounding wall are both connected to the shell, a sound-guiding cavity is defined by the tubular groove body and the shell, the sound-guiding cavity is in communication with the outside through the sound outlet, a sound-gathering cavity in communication with the sound-guiding cavity is defined by the surrounding wall and the shell, the sound-gathering cavity is in communication with the assembly cavity through the working opening, and the sound-guiding cavity and the sound-gathering cavity constitute the front cavity.

3. The loudspeaker housing according to claim 2, wherein the working opening is arranged directly opposite to the installation opening.

4. The loudspeaker housing according to claim 2, wherein an opening direction of the working opening is set at an angle with respect to an opening direction of the installation opening.

5. The loudspeaker housing according to claim 2, wherein in a direction from the working opening to the sound outlet, a cross-sectional area of the sound-guiding cavity is smaller than a cross-sectional area of the sound-gathering cavity.

6. The loudspeaker housing according to claim 2, wherein the surrounding wall is provided with a side blocking part around the working opening, and the sound-emitting unit is enabled to be retained in the side blocking part.

7. The loudspeaker housing according to claim 1, wherein the sound-guiding structure is arranged in the shell, the sound outlet is arranged in an outer wall of the shell, and the assembly cavity is formed between the sound-guiding structure and an inner wall of the shell.

8. The loudspeaker housing according to claim 2, wherein the sound-guiding structure is arranged in the shell, the sound outlet is arranged in an outer wall of the shell, and the assembly cavity is formed between the sound-guiding structure and an inner wall of the shell.

9. The loudspeaker housing according to claim 3, wherein the sound-guiding structure is arranged in the shell, the sound outlet is arranged in an outer wall of the shell, and the assembly cavity is formed between the sound-guiding structure and an inner wall of the shell.

10. The loudspeaker housing according to claim 4, wherein the sound-guiding structure is arranged in the shell, the sound outlet is arranged in an outer wall of the shell, and the assembly cavity is formed between the sound-guiding structure and an inner wall of the shell.

11. The loudspeaker housing according to claim 6, wherein the sound-guiding structure is arranged in the shell, the sound outlet is arranged in an outer wall of the shell, and the assembly cavity is formed between the sound-guiding structure and an inner wall of the shell.

12. A loudspeaker, comprising a sound-emitting unit and a loudspeaker housing,
wherein the loudspeaker housing comprises a shell and a sound-guiding structure which are integrally formed,
wherein the shell is provided with an assembly cavity and an installation opening, the assembly cavity is in communication with outside through the installation opening, and the sound-emitting unit is enabled to reach into the assembly cavity through the installation opening; and
the sound-guiding structure is provided with a front cavity, a sound outlet and a working opening, the front cavity is in communication with the outside through the sound outlet, and is in communication with the assembly cavity through the working opening, and when the sound-emitting unit is installed in the assembly cavity, the sound-emitting unit closes the working opening.

13. The loudspeaker according to claim 12, wherein the sound-guiding structure comprises a tubular groove body and a surrounding wall which are connected to each other, the tubular groove body and the surrounding wall are both connected to the shell, a sound-guiding cavity is defined by the tubular groove body and the shell, the sound-guiding cavity is in communication with the outside through the sound outlet, a sound-gathering cavity in communication with the sound-guiding cavity is defined by the surrounding wall and the shell, the sound-gathering cavity is in communication with the assembly cavity through the working opening, and the sound-guiding cavity and the sound-gathering cavity constitute the front cavity.

14. The loudspeaker according to claim 13, wherein the working opening is arranged directly opposite to the installation opening.

15. The loudspeaker according to claim 13, wherein an opening direction of the working opening is set at an angle with respect to an opening direction of the installation opening.

16. The loudspeaker according to claim 13, wherein in a direction from the working opening to the sound outlet, a cross-sectional area of the sound-guiding cavity is smaller than a cross-sectional area of the sound-gathering cavity.

17. The loudspeaker according to claim 13, wherein the surrounding wall is provided with a side blocking part around the working opening, and the sound-emitting unit is enabled to be retained in the side blocking part.

18. The loudspeaker according to claim 12, wherein the sound-guiding structure is arranged in the shell, the sound outlet is arranged in an outer wall of the shell, and the assembly cavity is formed between the sound-guiding structure and an inner wall of the shell.

19. The loudspeaker according to claim 12, wherein the sound-emitting unit fills the assembly cavity; or, a rear cavity is formed between the sound-emitting unit and an inner wall of the assembly cavity.

20. The loudspeaker according to claim 12, wherein a sealing rubber ring is sandwiched between the sound-guiding structure and the sound-emitting unit.
